(19) United States
(12) Patent Application Publication
(10) Pub. No.: US 2009/0013404 A1
(43) Pub. Date: Jan. 8, 2009

(54) Distributed defence against DDoS attacks

(75) Inventors: Stanley TaiHai Chow, Ottawa (CA); Douglas Wiemer, Ashton (CA); Jean-Marc Robert, Montreal (CA)

Correspondence Address: KRAMER & AMADO, P.C., 1725 DUKE STREET, SUITE 240, ALEXANDRIA, VA, 22314, US

(73) Assignee: ALCATEL LUCENT, Paris (FR)

(21) Appl. No.: 11/822,341

(22) Filed: Jul. 5, 2007

(51) Int. Cl. G08B 23/00; G06F 11/30

(52) U.S. Cl. 726/22

(57) ABSTRACT

When the processing resources of a host system are occupied beyond a trigger point by incoming requests, that host system issues a cool-it message that is broadcast throughout the network, eventually reaching edge routers that, in response to the message, throttle the traffic that they pass into the network. The throttling is applied in increasing amounts with increasing traffic volumes received at the edge routers. The cool-it messages are authenticated to ensure that they are not being used as instruments of a DoS attack. This mechanism also works to control legitimate network congestion, and it does not block users from a host system that is under attack.

### FIELD OF THE INVENTION

The invention is directed to secure transmissions over communication networks and in particular to an overload protection mechanism against distributed Denial of Service (DDOS) attacks and a method of implementing the defense.

### BACKGROUND OF THE INVENTION

Security is a critical feature in modern communication network; providing a security solution requires an understanding of possible threat scenarios and their related requirements. Network security systems need also to be flexible, promoting inter-operability and collaboration across domains of administration.

As the communication networks expand and converge into an integrated global system, open protocol standards are being developed and adopted with a view to enable flexibility and universality of access to collection and exchange of information. Unfortunately, these open standards tend to make networks more vulnerable to security related attacks. The Internet was designed to forward packets from a sender to a client quickly and robustly. Hence, it is difficult to detect and stop malicious requests and packets once they are launched. Furthermore, TCP (Transmission Control Protocol), was designed on the basis that system users would connect to the network for strictly legitimate purposes, so that no particular consideration was given to security issues. As many routing protocols rely on TCP (for example, border gateway protocol BGP uses TCP as its transport protocol) this makes them vulnerable to all security weaknesses of the TCP protocol itself.

In a Denial-of-Service (DoS) attack, a victim network or server is flooded with a large volume of traffic, consuming critical system resources (bandwidth, CPU capacity, etc). Distributed DoS (DDOS) attacks are even more damaging, as they involve creating artificial network traffic from multiple sources simultaneously. The malicious traffic may be generated simultaneously from terminals that have been “hijacked” or subverted by the attacker. A notable form of DDOS attack is access link flooding that occurs when a malicious party directs spurious packet traffic over an access link connecting an edge network of an enterprise to the public Internet. This traffic flood, when directed at a victim edge network, can inundate the access link, usurping access link bandwidth from the VPN tunnels operating over that link. As such, the attack can cause partial or total denial of the VPN service and disrupt operations of any mission-critical application that relies on that service.

DoS and DDos attacks can particularly harm e-commerce providers by denying them the ability to serve their clients, which leads to loss of sales and advertising revenue; the patrons may also seek competing alternatives. Amazon, E*Trade, and eBay are among recent victims.

Unfortunately, the IP addresses of the packets are not reliable to track the sources of the attacks since the attackers conceal theirs addresses and use fake addresses. This technique is known as spoofing. There are ways to detect the source of a DoS attack, such as using statistical analysis of the source addresses of the packets and using the evidence to take action against the attacker once the source has been identified. However, these methods become more difficult to apply when the attack comes from multiple sources, as in the case of DDOS attacks. There are also a large number of “packet marking” schemes that attempt to quickly identify the source of packets. A common problem with all of the marking schemes is that they don't provide a reliable means to trace the sources of the attack and they still require some way to mitigate the attack.

There are also methods of mitigating DoS and DDOS attacks. For example, to the IETF (Internet Engineering Task Force) has recommended ingress filtering, whereby ingress routers drop a packet that arrives on a port if the packet's source address does not match a prefix associated with the port (i.e. the packet does not arrive on the correct wire). Ingress filtering automatically stops attacks that use spoofing, and allows the origin of the attack to be determined when the DoS does not use spoofing, simply by examining the source addresses of attack packets.

Most known solutions for mitigating DoS and DDOS attacks are based on rate-limiting mechanisms that limit the rate of traffic incoming to a network element. A paper entitled “A taxonomy of DDoS Attacks and DDoS Defense Mechanisms” by Jelena Mirkovic, Janice Martin and Peter Reiher (UCLA Tech report #020018) provides a helpful overview of the flooding attacks and defenses available in communication networks. The article proposes a rate-limiting mechanism, which in the authors' view is a “lenient response technique”, which allows “some attack traffic through so extremely high scale attacks might still be effective even if all traffic streams are rate-limited.” Furthermore, this solution requires installing high-speed and high-reliability equipment in the core of the network, which in turn impacts on the network and services costs.

Another example of rate-limiting solutions to DoS attacks is provided by Cisco Systems, which sells a combination of appliances, namely a “Traffic Anomaly Detector XT 5600” for monitoring copies of traffic in the network backbone, and a “Guard XT 5650” for diverting traffic from different zones of the network that require protection. It appears these devices detect malicious traffic based on traffic levels. Again, the Cisco solution requires costly high-speed equipment in the core of the network and has other numerous drawbacks. For example, it leaves the network congested when under attack, as multiple copies of traffic flow in the network, so it may even introduce congestion without an attack. In addition, diverting the attack from certain zones of interest does not mitigate the attack, so that this solution does not solve the problem. Still further, Cisco's solution results in a complex set-up and configuration to define base statistics of “normal” traffic and to configure the protection zones, etc.

US patent application publication US 2002/0032853 (Chen et al.) describes a “moving firewall” system that attempts to identify and construct a signature for the attack packets, and then sends the constructed signature upstream for enabling filtering of packets with that signature. However, it is well known that it is difficult to construct signatures. Also, this system runs into the classical problem of distinguishing attack traffic from legitimate traffic. As an example, it is well known that when a URL is posted on a popular web-site, the web-site experiences a rash of accesses that is exactly the same as a stealth DDOS attack (the so called “slashdot effect”). With the Chen et al. solution, the legitimate traffic may not get through the network, unless the victim increases the bandwidth and processing capacity to “over-power” the attack.

IETF RFC “Pushback Messages for Controlling Aggregates in the Network” by Sally Floyd et al, abandoned in draft, and the paper entitled “Controlling High Bandwidth Aggregates in the Network” by Ratul Mahajan et al. research methods and systems of mitigating DoS attacks by applying the backpressure concept to “aggregates” of traffic that cause congestion. This research concentrates on automatic detection of malicious traffic by the routers and suggests a new router architecture to implement the backpressure. However, with this type of mechanisms, the attack traffic still enters the network and focuses on, and overwhelms the last router; alternatively, the victim may run out of some resource before the link is saturated. In addition, this and other “pushback” solutions require routers to automatically identify aggregates, and also require a new router architecture, which makes wide deployment of these solutions difficult.

The result of another thread of research is provided by the paper “Defending Against Distributed Denial-of-Service Attacks with Max-min Fair Server-Centric Router Throttles” by David K. Y. Yau et al. The authors apply an adaptive throttle algorithm to packets with a view to achieving a “level-k max-min fairness”. However, it appears from the text that the proposed “router throttles” are not reliable, and that, to quote from the paper: “we must achieve reliability in installing router throttles, otherwise the throttle itself becomes a DoS attack tool. Also, due to the adaptive nature of the throttle, throttle requests must be efficiently and reliably delivered”. Other disadvantages are that the system drops packets at random; however, if a packet in the middle of a sequence is dropped, the whole sequence is wasted (or requires more resends which aggravates the congestion). Still further, legitimate users who want to access the target are usually blocked. And, the paper acknowledges that issues such as authentication and reliable transport require servers to have a complete deployment of co-processors (or watchers) in order to obtain an efficient attack mitigation solution.

The reliability and security of an IP network is essential in a world where computer networks are a key element in intra-entity and inter-entity communications and transactions. Therefore, improved methods are required detecting and blocking DDOS attacks over IP networks.

### SUMMARY OF THE INVENTION

It is an object of the invention to provide an overload protection mechanism and method for controlling the rates of traffic flows in a communication network.

This invention addresses the more general problem of network overload, such as unanticipated legitimate usage explosion (known as the flash crowd problem), and the narrower problem of mitigating DoS or/and DDOS attacks; it addresses these problems automatically, with minimal human intervention, and with minimal initial network re-configuration. Thus, the mechanism and method of the invention may be primarily defined as a means for protecting the network against overload, with a secondary effect of protecting a victim of a flooding attack. When a system is overloaded or under a DoS/DDoS attack, it informs the network to slow down the incoming traffic, resulting in controlling the rates of traffic across the entire network.

Accordingly, the invention provides a method for overload protecting a host system connected in a communication network, comprising the steps of: i) monitoring at the host system a traffic level parameter to detect when the traffic level parameter exceeds a locally configured trigger point; ii) generating a cool-it message when said traffic level parameter exceeds said trigger point, said cool-it message including an identification of the host system and throttle instructions; iii) broadcasting the cool-it message over said network as a cool-it broadcast message to a plurality of cool-it capable nodes, provided at the border of said network; and iv) at said cool-it capable nodes, shaping the traffic destined to said host system by dropping packets destined to said host system based on the throttle instructions extracted from the cool-it capable node.

The invention is also directed to a distributed overload protection system for a communication network comprising, at a host system: a trigger point configuration module for configuring a trigger point and associated throttle instructions specific to the host system; an overload detector for monitoring a traffic level parameter to detect when the traffic level parameter exceeds a locally selected trigger point; a cool-it message generator for generating a cool-it message when the traffic level parameter exceeds the trigger point, the cool-it message including an identification of the host system and throttle instructions; and means for broadcasting the cool-it message over the network as a cool-it broadcast message to a plurality of cool-it capable nodes provided at the border of the network.

This specification uses the term “traffic level parameter” for defining an overload condition. An “overload condition” defined locally by the host system in terms of CPU occupancy, bandwidth usage, latency of response from database backend, etc. Also, other criteria are equally acceptable for defining an overload condition, including a combination of traffic parameters.

Also, in this specification, the term “network node” is used interchangeably with the term “system” and refers to switches, routers, servers, subscriber terminals, sub-networks, LANs, etc. The term “packet” refers to a data unit protocol, and can include IP packets, cells, frames, etc. The term “host system” refers to a network node that is overloaded in terms of traffic. More specifically, the term “victim” is used for a host system under a DoS/DDoS attacks.

Advantageously, with the mechanism of the invention, the network is protected since selected packet flows are dropped right at the entry into the network, so the network as a whole does not waste resources transporting packets that are destined to be dropped downstream. The victim is protected due to the fact that the mechanism and method of the invention increases the probability of blocking attack traffic, while allowing legitimate traffic. In addition, the solution is much simpler that the currently available solutions described above. For example, the present invention differs from the solution proposed by the abandoned RFC on pushback messages in that it does not attempt to identify the attacking aggregate, which is in fact impossible in a Distributed DoS (DDOS) case.

Due to the fact that the overload protection mechanism and method of the invention focuses on protecting the network as a whole instead of trying to identify the sources of attack, several functional differences from the currently available methods and systems described above are apparent. Namely:

The invention is simple to set up, and it does not require any specialized hardware;

No additional bandwidth is needed. On the contrary, bandwidth is saved in that flows are discarded at the entry into the network rather than at the victim.

The effect of any DDOS attack on the network, whether it is the enterprise network, the ISP carrier network, or the whole Internet, is mitigated to a very large degree, even for the intended target of the attack.

Useful traffic gets through and useful work gets done for “innocent” users who want to access the intended target, as these by-standers have a good chance of getting through to the victim.

“Innocent” servers that happen to be close to the victim from the network topology point of view feel little impact from the DDOS attack.

The source(s) of the attack traffic is automatically traced and isolated.

### BRIEF DESCRIPTION OF THE DRAWINGS

The foregoing and other objects, features and advantages of the invention will be apparent from the following more particular description of the preferred embodiments, as illustrated in the appended drawings, where:

FIG. 1 illustrates how a DDOS attack works;

FIG. 2 illustrates the block diagram of a network node equipped with the overload protection mechanism according to the invention;

FIG. 3a shows a block diagram of a cool-it capable node,

FIG. 3b shows a block diagram of a cool-it aware node; and

FIG. 4 shows how the impact of the DDOS attack on the innocent by-standers is addresses with the mechanism and method of the invention.

### DETAILED DESCRIPTION

The invention is directed to an overload protection mechanism and a method for identifying an overload condition at a network entity and adjusting the traffic rate for addressing the overload. As a particular case, the invention is directed to a protection mechanism against DoS and DDoS attacks.

While the current approaches, as the ones described above, attempt to block attacks completely, the overload protection mechanism and method of the present invention do not attempt to be either fair or complete in the sense that some attack packets still get to the victim and some legitimate packets are blocked. Furthermore, while in the current DoS detection and prevention systems the routers try to protect the victims transparently and without the victims even knowing that is under attack, the invention uses a trigger point set-up by the victim, which is adaptive and fully controlled by the victim. The mechanism of the invention is well suited for a typical switch, router, etc. and does not require addition of complex hardware and software to the architecture of the system to be protected. As such, the mechanism of the invention can readily scale to the whole internet.

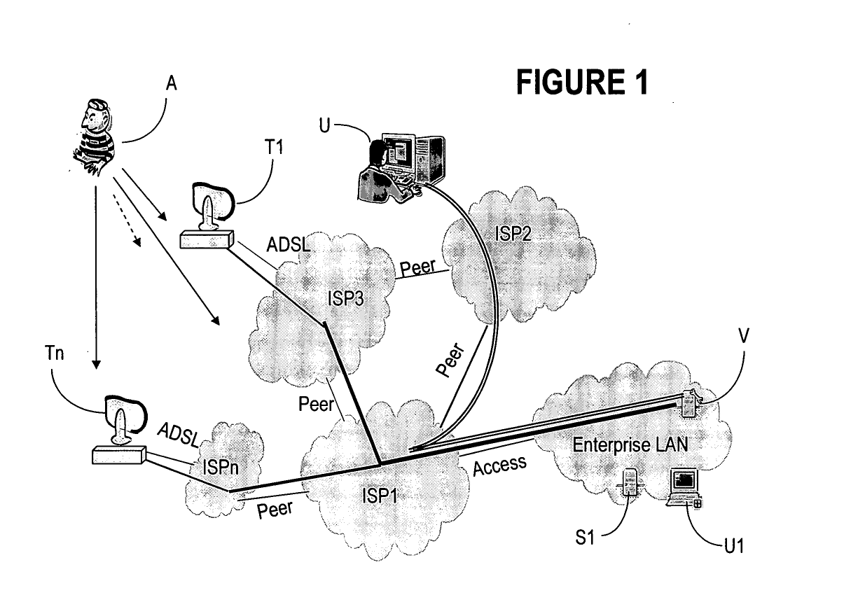

FIG. 1 illustrates how a DDoS attack works, and it illustrates particularly the effect of such an attack on the victim by-standers. This Figure shows by way of example a plurality of ISP (Internet Service Provider) networks denoted with ISP1 to ISPn and an enterprise LAN. The LAN is connected to IPS1 over an access link, and traffic is exchanged with other ISP networks over peering connections. In this example, a legitimate user U connected to IS2 wishes to establish a connection to a client of the LAN, which is here the victim V of a DDoS attack. The legitimate traffic, shown here by double lines, from user U to victim V normally passes from ISP2 to ISP1 on the peering link between these networks, then from ISP1 to the enterprise LAN over the access link.

A DDoS attack take place by flooding the victim V with traffic from a plurality of points, shown here as the terminals T1 . . . Tn user connected to ISP3 to ISPN. A most common scenario is when an attacker A installs a bot on terminals T1 to Tn, transparently to the legitimate user of these terminals. A bot is a software program designed specifically for residing unnoticed on a terminal and which is capable to start sending irrelevant or malicious traffic to a certain attack target with a view to force the victim out of operation. Home personal computers not protected by firewalls or other types of defense systems are easy targets and often become bots.

As seen on FIG. 1, traffic coming from ISP3 . . . ISPn to ISP1 (illegitimate traffic) and from ISP2 (legitimate traffic) is aggregated by ISP1 and directed to the victim V over the access link to the enterprise LAN. FIG. 1 shown the attack traffic in a continuous line whose thickness grows as more illegitimate traffic is aggregated towards the victim. When the access link reaches its maximum capacity, the legitimate traffic from U cannot reach the victim any more. In addition, when the attackers initiate a flood of traffic, one effect is to saturate bandwidth of links close to the victim. This means that legitimate users referred to here also as “innocent bystanders”, such as server S1 and another user U1, cannot access other services available over network ISP1. This usually only happens to servers “close” to the victim, but in large scale attacks, the whole internet can be affected.

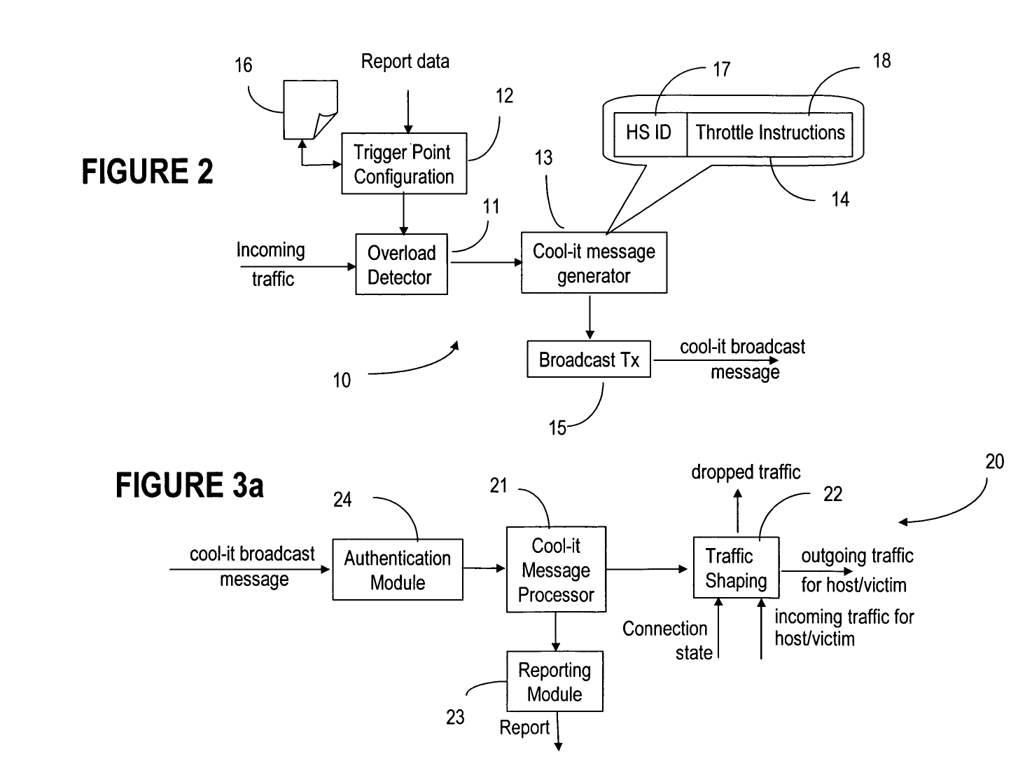

FIG. 2 illustrates the block diagram of a network node equipped with the overload protection mechanism according to the invention. Thus, network entities that are potential victims of DoS/DDoS attacks, or, more generally, host systems that need to be protected against traffic overload, are equipped with a means for detecting an overload, denoted with 11. To reiterate, since the host system itself declares that it is overloaded, it may use any criteria to decide if it is overloaded. An overload is declared at some trigger point, selected by the host system based on traffic level parameters measured by the node. Such traffic level parameters could be the CPU occupancy, bandwidth usage, latency of response from database backend, etc. The trigger point identifies the overload condition (or a DoS/DDoS attack) when the traffic level parameter exceeds the trigger point. For example, a trigger point may be set at 80% bandwidth saturation, or 70% CPU busy; other criteria are equally acceptable. Also, combination of traffic parameters may also be used to specify the trigger point.

The trigger point is selected based on the host system design specifications. Preferably, these are also selected taking into account statistics collected for the respective system, if available. If a connection has only a low level of traffic (approximately normal levels determined statistically for that entity), then the packets on that connection are treated as legitimate traffic and let through. As the traffic level increases, the trigger point is reached and the mechanism of the invention starts to shape the traffic by allowing only a percentage of the packets through. At very high levels, the allowed-percentage can drop to zero. The goal is to only let in as much traffic as can be handled by the respective system, while maximizing the probability of legitimate traffic getting through.

According to this invention, the host system maintains an association between one or more trigger points and throttle instructions. The throttle instructions are also at the host system's discretion; preferably, they differ with the type and gravity of the overload. These instructions are also selected based on host system design specifications and take into account statistics collected for the respective system, if available. Throttle instructions may be simple requests for a rate decrease based on the trigger point value and the current value of the traffic level parameter measured. In this case, the instructions specify a certain traffic rate setting that is acceptable to the host system, or a specific connection requests rate, etc.

Throttle instructions may be more complex instructions, with multiple rate settings or connections request rates that are to be maintained between different values (thresholds) set for the respective traffic level parameter. An example of complex throttle instructions could be: if the current connections request rate in the incoming traffic is less than a threshold of X connection requests per second, let all packets through, if the current connections request rate is over threshold X but less than a threshold Y, let Z percent of packets through, and so on. To summarize, selection of the trigger point (both the traffic level parameter selected for triggering the cool-it action and the value of the parameter) depends on the type of system, and may be established by way of agreement between the network provider, service provider customer, etc.

The trigger point and the associated throttle instructions are stored at a trigger point configuration module 12, as shown at 16. The trigger point and the associate throttle instructions may be configured manually and may be re-configured automatically based on feedback received as report data, as discussed later.

Once the trigger point is reached, the host system notifies its neighbors of this event, indicating that it is busy. To this end, a cool-it message generator 13 generates a cool-it message 14. Cool-it message 14 is preferably a new type of an ICMP (Internet Message Control Protocol) packet; an embodiment of message 14 is shown in the insert appended to the generator 13. In this embodiment, the message provides an identification of the host system, as shown at 17, and the throttle instructions 18 corresponding to the trigger point. The host system identification may be for example the host system's IP address and the throttle instructions may provide a specific traffic rate setting that the respective host system is prepared to process. Other embodiments of the cool-it message are also possible.

The cool-it message is then sent to the broadcast address of the host system, as shown by the broadcast transmitter 15, which in turn broadcasts the cool-it message over the network as a cool-it broadcast message.

The nodes of the network are adapted to pass the cool-it message to the source/s of the traffic received by the host system. Some nodes of the network, called “smart nodes” are adapted to process the cool-it message in a specific way. The smart nodes are classified into two categories: “cool-it-capable” and “cool-it aware” nodes. Other nodes of the network that do not process the cool-it broadcast message in any way are called “dumb nodes” or “cool-it-oblivious” nodes.

As the name states, a cool-it-capable node is adapted to process cool-it broadcast messages and to initiate traffic shaping according to the throttle instructions provided in the cool-it message. In general, these are access NEs, so that some traffic is advantageously discarded at the input to the network. When a cool-it broadcast message arrives at a cool-it-aware node, the node checks if the message arrived on the correct wire, and then relays the broadcast message to the other wires. The cool-it-oblivious class of nodes includes hubs and switches connected in the network core.

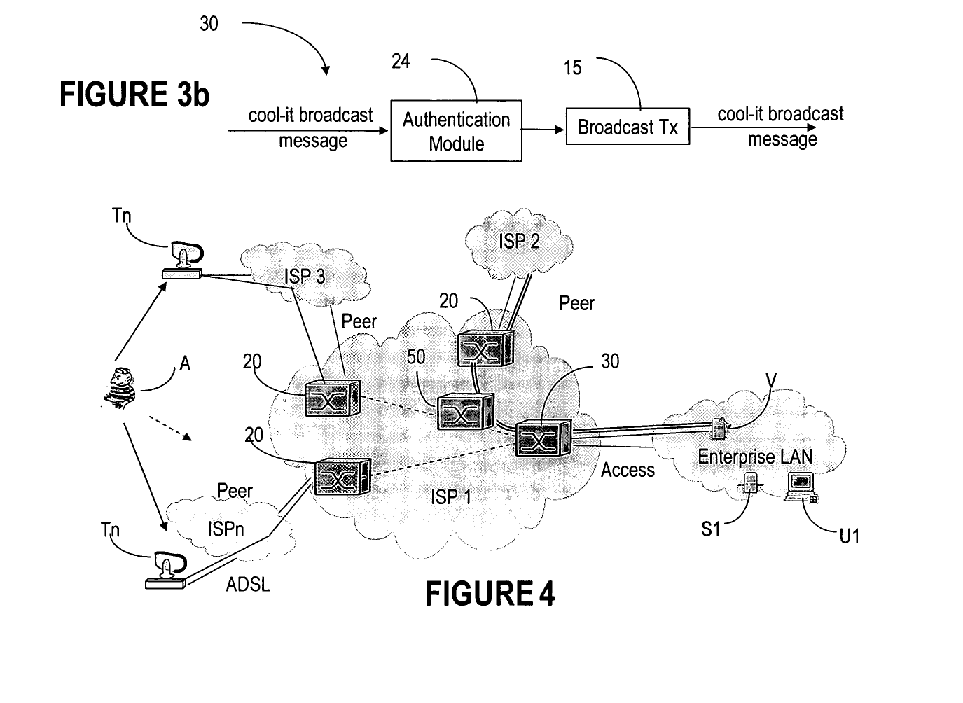

The block diagram of a cool-it capable node 20 is shown in FIG. 3a. Cool-it capable node 20 comprises a simple authentication module 24 that checks if the message arrived on the correct wire. This simple authentication ensures that an attacker will not be able to use cool-it messages for a DDOS attack. If the message is authentic, a processor 21 processes the cool-it broadcast message obtained from the network to identify the host system and to extracts the throttle instructions provided by the host system. The throttle instructions are then provided to a traffic shaping module 22. Shaping module 22 applies the throttle instructions and accordingly shapes the outgoing traffic destined to the host system. For adjusting the rate of the outgoing traffic destined to the host system, node 20 discards the required amount of traffic by dropping packets to adjust the rate of the outgoing traffic to the requested rate decrease.

Node 20 is capable of blocking or allowing packets on a per connection basis, so that only the traffic on the connections to the victim is shaped. For DDOS attacks with UDP packets, the cool-it-capable device may be designed to behave like a simple stateless firewall and block packets randomly. In case of a SYN flooding attack, complete TCP-flows are dropped instead of random packets, maximizing the amount of useful work for the victim and the innocent by-standers.

In the case of a typical attack against a web server, both the legitimate and attack traffic go through TCP connections to a specific port, called port 80. In order for an innocent bystander to successfully access the web server, it must be able to open a TCP connection, send multiple HTTP requests, get results, etc.; the TCP connection will pass many packets in both directions. All the packets for the connection must get through; if any of the packets are dropped, the flow is disrupted. This means the cool-it message node 20 should also be able to track the state of the connections; this is termed “stateless versus statefull packet inspection”. Mechanisms to address this problem are known as they are also addressed by the firewalls.

There are many possible embodiments to throttle the traffic by flow. This can be accomplished through traditional methods of ingress traffic shaping, egress traffic policing, forwarding information table lookup rules, or through exception processing in the switch/router for all traffic with destination address that matches the attacked system. The preferred embodiment is to throttle on the ingress side of the node, i.e., at the connection port of the DSLAM (Digital Subscriber Line Access Multiplexer). This stops the attack traffic at the earliest point, avoiding possible saturation of switching fabric or other resources in the respective node 20. For many access switches there is already a mapping of forwarding paths; in this case for SYN packets that are rejects, the device can just drop the forwarding path.

Since tracking the state of connections requires CPU cycles and memory, for peering points with high volume traffic that is combined with non-attack traffic, it is possible to make use of an available Deep Packet Inspection (DPI) module, if available, that can filter and drop at the connection level. DPI selects packets to drop as part of the throttling process in order to drop a higher percentage of DoS packets, e.g. by dropping more packets at the connection level thereby throttling less legitimate user traffic on existing connections. Alternatively, where a DPI module is not available, traffic intended for the target system can be forwarded to any exception processing capability (i.e., house-keeping processor on board or control card).

Returning to FIG. 3a, the cool-it capable nodes may also be equipped with a reporting module 23. The reporting can take many forms and preferably includes information on the actual traffic presented at the victim device and the amount of the traffic that was allowed. The “amount” of traffic may be provided as a percentage, or the number of flows, or the final traffic rate after the traffic is dropped, etc. The reporting can be sent to a number of places: the NOC/SOC (Network Operations Center or Security Operations Center) that owns the device, the NOC/SOC that owns the victim, directly to the victim. The cool-it capable nodes 20 are configured to report this information to their NOC/SOC, who will then aggregate the reports and pass the information to the host system 10 directly, or via intervening NOC/SOC's. This is shown by the arrow called ‘report data’ on FIG. 2. The trigger point configuration module of the host system 10 can then use this information to adjust the trigger point in order to change the throttle instructions in the cool-it message, as needed. The reported information may also be used to bill for per-incident costs or by duration, and so on.

The overload detector 11 also recognizes when a sufficient amount of traffic has been dropped, when the current traffic level parameter drops under the trigger point. When this happens, the cool-it message includes specific throttle instructions that will reset the cool-it capable node/s to stop throttling the incoming traffic. Alternatively, a distinct ‘restore-it’ message may be transmitted from the host system to the cool-it node/s for resetting the cool-it capable node/s. The term ‘sufficient amount’ of dropped traffic is a relative term which refers to the amount of traffic discarded by a cool-it capable node until the traffic level parameter measured at the host system drops under the respective trigger point.

FIG. 3b shows an embodiment of a cool-it aware node 30. As indicated above, such nodes are provided with an authentication module 24 for recognizing and authenticating the cool-it broadcast message. As in the case of the cool-it capable nodes 20, this module simply checks if the broadcast message arrived on the correct wire, based on the address of the host system. If the message is authentic, node 30 broadcasts it to the neighboring node, as shown at 15.

FIG. 4 shows how the impact of the DDoS attack on the innocent by-standers is addresses with the mechanism and method of the invention. Clearly, if all nodes of a network are at least cool-it-aware, then the authentication assures that the cool-it message actually came from the wire connected to the end system. Adding cool-it oblivious devices 50 in the network does not destroy this trust since most natural usages of switches and hubs will preserve the trust but only to the granularity of the subnet behind the connection. If the whole subnet is trusted, then the authenticity of the message is assured. If the subnet is not trusted, then the DDOS is likely to be of secondary concern. For a carrier, it is also possible to have all edge devices be cool-it-aware and leave all interior devices be cool-it-oblivious. This turns the entire interior of the network into a single zone; as long as the whole zone is trusted (probably true for a carrier) all cool-it messages will be authentic.

The result is that the cool-it message automatically propagates through the network without any human intervention and reaches the “edge” of the network, whether it is the departmental LAN, the enterprise WAN, the carrier network, or the whole Internet. In each case, the traffic shaping or throttling happens at the earliest cool-it-capable node 20 in the way of the broadcast message. At these nodes, DDOS attack traffic, which is by definition high volume, is progressively throttled; unfortunately, normal traffic that shares the wire with attack traffic will be similarly throttled. Normal traffic that does not share the wire with the attack traffic however will go through unhindered.

The net result depends on the boundary of the network. If the overload protection mechanism of the invention is deployed throughout the whole internet, attack traffic would be throttled at the source. Each bot would generate attack traffic, but be throttled, for example, at the access DSLAM of the bot, so that only a tiny portion of attack traffic will get into the network, as seen in FIG. 4. This means even a huge bot-army would have minimal effect on the network as a whole. The intended victim would suffer little harm: an increase of non-sense requests. Since there is no congestion anywhere, innocent by-standers are not affected at all.

The same advantage is available to a carrier or enterprise. In the carrier case, deploying the invention at all peering points and access points will prevent any DDOS attack from causing internal congestion, as shown in FIG. 4. The intended victim is not affected; other subscribers (even the ones on the same sub-network as the victim) are not affected. The congestion could still be felt at the peering points so WAN connectivity may be affected (since the full attack traffic will be present on the peering point and could congest that link to the point of excluding other innocent traffic).

A numerical example is provided to illustrate the impact of the invention, in reducing the impact of a DDOS attack, for the legitimate users of a victim. The example used is for “fast” bots attacking a moderately popular site. Let's say there are U concurrent users of the site; for a popular site, U=10K. Let's also assume that each user generates one connection to the victim during some length of time T (e.g. T=10 seconds). The number of bots is denoted with B, and it is assumed that each bot generates N connections to the victim during the same length of time. For a moderate attack, B=1K and N=1K or larger. If N*B is large enough, without the invention, the traffic will cause routers to drop packets at random, most probably due to running out of buffer/queue space somewhere. This is one of the main ways a DDoS works. In the above example, in each unit of time, the portion of legitimate traffic is U/(U+N*B), which means that just 1% of the traffic is legitimate and the attack will essentially shutdown the website. In other words, most probably no legitimate user will succeed in having a complete connection.

With this invention, let's say the throttle directives are set so that first SYN packet gets through, then only one SYN in 10 gets through, then one SYN in 100, and nothing over 100 gets through. This means N is now reduced to N1=3. The total traffic is now U+N1*B: the attack traffic is attenuated by roughly N1/N, which is a factor of over 3,000 in this example. The percentage of useful traffic is now U/(U+N1*B). This means just over 77% of traffic is legitimate, or that only a quarter of the incoming traffic is attack traffic. As it appears from the above result, the server needs to be only slightly over-provisioned to handle even large attacks. Most importantly, all legitimate traffic will get through at this slight over-provisioning of the server capacity.

Clearly the results depend on the specific details, but the above example illustrates the power of this trivial statistical selection. It is simple to show that the improvement is driven by the throttle directives and that even for huge attacks, adjusting the rate of the incoming traffic will result in dramatic improvements.

The invention is not suitable for mitigating attacks with “slow” bots that attempts to be totally indistinguishable from legitimate users; however, this attack scenario is not all that worrying. In fact, this invention basically converts a fast-bot attack into a slow-bot attack. A numerical example for this scenario is provided next. Let's now say that as before, there are U users, each generating one (1) connection to the victim during time T; for a popular site, U=10K. Let's assume that there are B bots, each generating N connections to the victim during the same time T; for a moderate attack of slow bots, B=1K and N=1. This means that the product N*B=1k is not very large. Now, in each unit of time, the portion of legitimate traffic is U/(U+N*B); which means 90% of the traffic is legitimate and the attack will only add 10% to the load of the website. In general, for slow bots to succeed there must be many more bots than active users. In any case, it is easy to defend against slow bots by just adding more capacity on the access link. For this analysis, we will assume that capacity is held constant.

Under this invention, let's say the throttle instructions are set so that first SYN gets through, then one SYN in 10 gets through, then 1 in 100, and nothing over 100 SYNs gets through. This means that N stays at 1. The percentage of useful traffic is now U/(U+B), which means the legitimate users are competing with the bots on an equal footing; this is to be expected given that each bot is indistinguishable from user. For a large site, the attack army has to be very large to be effective.

On the example shown in FIG. 4, the web server V is under attack (be it Apache on Linux, IIS on Windows, or any web server), meaning a “bot army” has been unleashed, or equivalently, the site has just been popularized on TV. Each bot will be continually trying to open a TCP connection on port 80. The aim of the attack, or the result of the TV exposure, is to tie up all available bandwidth, or CPU cycles so that legitimate users cannot access the web site. Web server V starts to spend more and more CPU cycles on incoming requests. At the configured trigger point, say 80% bandwidth saturation (or 70% CPU busy, or whatever criteria are used), it notifies its neighbors that it is busy. Essentially, for each wire that carries incoming traffic, a “cool-it” broadcast message goes out.

Each cool-it oblivious device in the network (not shown) will just treat the cool-it broadcast message as a normal broadcast packet and forward it, without verifying the authenticity of the message in any way. Each smart device (cool-it aware and cool-it capable nodes) are configured to either forward the cool-it message or to process it. The devices on the edge of the network (the cool-it capable nodes) are set to process the message, the devices in the interior of the network (cool-it aware nodes) are set to forward the message. The smart devices are also configured to “authenticate” the message by checking that the message came from the correct connection. Once the cool-it message arrives at the cool-it aware devices, these will start throttling the traffic on the connections going to the web server V, applying the throttle instructions.

Now, the level of traffic arriving at server V decreases, as all cool-it nodes throttled the traffic for the victim. If the traffic is now in the normal limits, nothing happens. If the level of traffic getting to the victim is still higher than the trigger point, the victim broadcasts a new cool-it message, with instructions adequate to the new level of traffic.

That is, any packet destined for the IP would go to that connection. Ideally, we want even the cool-it oblivious devices to “authenticate”. This assures that the message actually came from the real Web Server V. (The system would have to be already severely compromised for the attacker to send out these messages.)

1. A method for overload protecting a host system connected in a communication network comprising the steps of:
i) monitoring at the host system a traffic level parameter to detect when the traffic level parameter exceeds a locally configured trigger point;
ii) generating a cool-it message when said traffic level parameter exceeds said trigger point, said cool-it message including an identification of the host system and throttle instructions;
iii) broadcasting the cool-it message over said network as a cool-it broadcast message to a plurality of cool-it capable nodes, provided at the border of said network; and
iv) at said cool-it capable nodes, shaping the traffic destined to said host system by dropping packets destined to said host system based on the throttle instructions extracted from the cool-it capable node.

2. A method as claimed in claim 1, wherein step i) comprises:
defining said traffic level parameter to characterize an overload condition of the host system;
selecting the trigger point for specifying said overload condition whenever the traffic level parameter exceeds the trigger point; and
associating throttle instructions to the trigger point based on design specifications of the host system.

3. A method as claimed in claim 1, wherein the cool-it message is an ICMP packet.

4. A method as claimed in claim 1, wherein the throttle instructions provide a specific traffic rate setting that the host system is capable to process for avoiding said overload condition.

5. A method as claimed in claim 1, wherein the throttle instructions provide a specific connections request rate that the host system is capable to process for avoiding said overload condition.

6. A method as claimed in claim 5, wherein the throttle instructions provide a threshold for indicating that all connection requests received at a cool-it capable node should be processed, if a current connections request rate measured at the cool-it node is less than the threshold.

7. A method as claimed in claim 5, wherein the throttle instructions provide a plurality of thresholds, each associated with a connections request rate for indicating the number of connection requests that should be processed at the cool-it capable node if a current connection request rate measured at the cool-it node is higher than the respective threshold.

8. A method as claimed in claim 1, further comprising, when the communication network is provided with a network operations center, NOC/SOC:
transmitting from each cool-it capable node a report to the NOC/SOC, the report identifying the respective cool-it capable node and the amount of traffic dropped during step iv);
assembling at the NOC/SOC report data indicating the amount of traffic dropped by all cool-it nodes in said network and transmitting the report data to said host system; and
adjusting the throttle instructions based on said report data.

9. A method as claimed in claim 8, wherein the cool-it aware node stops discarding packets when the throttle instructions indicate that the traffic level parameter is decreased under the trigger point.

10. A method as claimed in claim 8, wherein the cool-it aware node stops discarding packets on receipt of a stop cool-it message.

11. A method as claimed in claim 1, wherein step iii) comprises:
selecting a number of nodes in the core of the network to operate as cool-it aware nodes;
equipping each cool-it capable node and the cool-it aware node of the network with an authentication module;
determining if the cool-it broadcast message arrives at the respective at authentication module on a wire that connects said respective node with the host system;
dropping said cool-it broadcast message if it arrives on a wire that does not connect said node with said host system.

12. A method as claimed in claim 1, wherein said overload condition is due to a distributed denial of service attack.

13. A method as claimed in claim 1, wherein, when the host system is a web server, step iv) comprises:
authenticating the cool-it message by verifying if the cool-it broadcast message arrives at the cool-it capable node on a wire that connects the cool-it capable node with the host system;
processing the cool-it broadcast message for extracting the throttle instructions; and
identifying in the incoming traffic arriving at the cool-it capable node, traffic flows destined to the host system, and dropping a number of connections destined to said host system based on the throttle instructions.

14. A distributed overload protection system for a communication network comprising, at a host system:
a trigger point configuration module for configuring a trigger point and associated throttle instructions specific to said host system;
an overload detector for monitoring a traffic level parameter to detect when the traffic level parameter exceeds a locally selected trigger point;
a cool-it message generator for generating a cool-it message when said traffic level parameter exceeds said trigger point, said cool-it message including an identification of the host system and throttle instructions; and
means for broadcasting the cool-it message over said network as a cool-it broadcast message to a plurality of cool-it capable nodes provided at the border of said network.

15. A system as claimed in claim 14, wherein a cool-it capable node comprises:
a cool-it message processor for extracting the throttle instructions from said cool-it broadcast message; and
means for shaping the traffic destined to the host system by dropping packets destined to the host system based on the throttle instructions.

16. A system as claimed in claim 15, wherein the cool-it capable node further comprises a reporting module for providing feedback report data to said trigger point configuration module for adjusting the throttle instructions according to the report data.

17. A system as claimed in claim 16, wherein the cool-it message generator generates a restore-it message when said traffic level parameter decreases below said trigger point, said restore-it message including an identification of the host system and instructions for resetting the cool-it capable nodes.
